(19) United States
(12) Patent Application Publication
(10) Pub. No.: US 2023/0053246 A1
(43) Pub. Date: Feb. 16, 2023

(54) VEHICLE-MOUNTED FIXING DEVICE FOR ELECTRONIC PRODUCTS

(71) Applicant: KAIQUAN HUANG, Huangshi (CN)

(72) Inventor: KAIQUAN HUANG, Huangshi (CN)

(21) Appl. No.: 17/886,410

(22) Filed: Aug. 11, 2022

(30) Foreign Application Priority Data
Aug. 12, 2021 (CN) 202121883443.1

(51) Int. Cl. B60R 11/02

(52) U.S. Cl. CPC B60R 11/0252; B60R 2011/0015

(57) ABSTRACT

The present application relates to the technical field of fixing devices for electronic product, and in particular, to a vehicle-mounted fixing device for electronic products. A vehicle-mounted fixing device for electronic products, comprising an elastic webbing detachably connected to the backrest of a scat of a motor vehicle; a fixing base detachably connected to the elastic webbing; and an elastic fastening element connected to the fixing base, for fastening the electronic product to the fixing base. Through the technical solution of the present application, the electronic product can be fastened to the backrest of the seat of the motor vehicle, so as to prevent the electronic product from shaking or even falling and damage due to the bumpy driving of the motor vehicle when the electronic product is directly held.

### CROSS-REFERENCE TO RELATED APPLICATIONS

This application claims the benefit and priority of Chinese patent application No. 202121883443.1, filed on Aug. 12, 2021, disclosure of which is hereby incorporated by reference in its entirety.

### TECHNICAL FIELD

The present application relates to the technical field of fixing devices for electronic product, and in particular, to a vehicle-mounted fixing device for electronic products.

### BACKGROUND

On a motor vehicle, it is often necessary to play with various electronic products, such as tablet computers, mobile phones, game consoles, mobile communication products, TV sets, etc. These products are fragile and easily damaged. However, during the driving of the motor vehicle, it is inevitable to shake and bump, which may easily cause the electronic product to fall and be damaged due to shaking.

### SUMMARY

The purpose of the present application is to provide a vehicle-mounted fixing device for an electronic product in view of the deficiencies of the prior art, which aims to fix the electronic product and prevent the electronic product from being damaged by shaking and falling due to the bumpy driving of the motor vehicle.

The present application achieves the above purpose through the following technical solutions: A vehicle-mounted fixing device for electronic products, comprising:

an elastic webbing, detachably connected to the backrest of the motor vehicle seat;

a fixing base, detachably connected to the elastic webbing;

an elastic fastening element, connected to the fixing base, for fastening the electronic product to the fixing base.

As a further technical solution of the present application, the elastic fastening element comprises elastic cord or nylon cord or elastic band.

As a further technical solution of the present application, the elastic webbing comprises nylon webbing or elastic band or nylon mixed elastic band.

As a further technical solution of the present application, material of the elastic fastening element comprises silica gel; the fixing base comprises a first layer board and a second layer board, wherein the elastic fastening element is clamped between the first layer board and the second layer board, the left and right ends of the elastic fastening element respectively protrude from the first layer board and are attached to an upper surface of the first layer board in a curved manner.

As a further technical solution of the present application, the elastic webbing is provided with a first Hook-and-loop fastener.

As a further technical solution of the present application, further comprising a second Hook-and-loop fastener and the fixing base pasted on the elastic webbing through the second Hook-and-loop fastener.

As a further technical solution of the present application, the elastic fastening element is arranged on a front end of the fixing base, and a loop surface of the second Hook-and-loop fastener is arranged on a rear end of the fixing base, and a hook surface of the second Hook-and-loop fastener is arranged on the elastic webbing.

As a further technical solution of the present application, the elastic fastening element is arranged on a front end of the fixing base, and a hook surface of the second Hook-and-loop fastener is arranged on a rear end of the fixing base, and a loop surface of the second Hook-and-loop fastener is arranged on the elastic webbing.

As a further technical solution of the present application, the first layer board and the second layer board are fixed by screws, and a silicone anti-skid pattern is arranged in the middle of the elastic fastening element.

### Beneficial Effects of the Present Application

In the technical solution of the present application, the elastic webbing is fixed to the backrest of a seat of the motor vehicle, the electronic product is fastened to the fixing base by the elastic fastening element, and then the fixing base is fixed to the elastic webbing, so that the electronic product can be tightly fastened to the backrest of the seat of the motor vehicle to prevent the electronic product from shaking or even falling due to the bumpy driving of the motor vehicle when the electronic product is directly held.

In addition, the inventors have found that the bumpy driving of the motor vehicle may cause the electronic product to shake. Staring at the screen of a shaking electronic product, such as a tablet computer or a game console, will cause the angle of the lens of the eye to change continuously. If you do this for a long time, eyes will be very tired and it will easily lead to myopia. Through the technical solution of the present application, the electronic product is fixed on the backrest of the front seat, so that the vibration of the electronic product is consistent with the bump frequency of the motor vehicle, and the changing angle and frequency of the eye lens are reduced, thereby effectively reducing and alleviating eye fatigue.

### BRIEF DESCRIPTION OF DRAWINGS

FIG. 1 is a schematic structural diagram of the elastic webbing according to the present application.

FIG. 2 is a schematic structural diagram of the fixing base according to the present application.

FIG. 3 is a schematic structural diagram of the fixing base according to the present application from another perspective.

### REFERENCE SIGNS

1. Elastic webbing;

2. Fixing seat, 21. First layer board, 22. Second layer board, 23. Elastic fastening element;

31. Loop surface of the first Hook-and-loop fastener, 32. Hook surface of the Hook-and-loop fastener;

41. Loop surface of the second Hook-and-loop fastener, 42. Hook surface of the second Hook-and-loop fastener;

51. Screw

### DETAILED DESCRIPTION

The present application will be described in detail below with reference to the accompanying drawings.

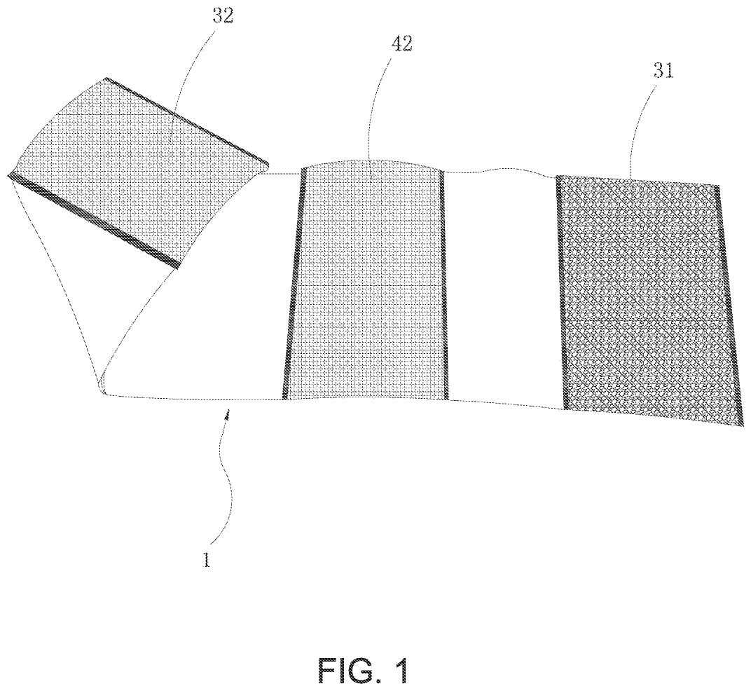

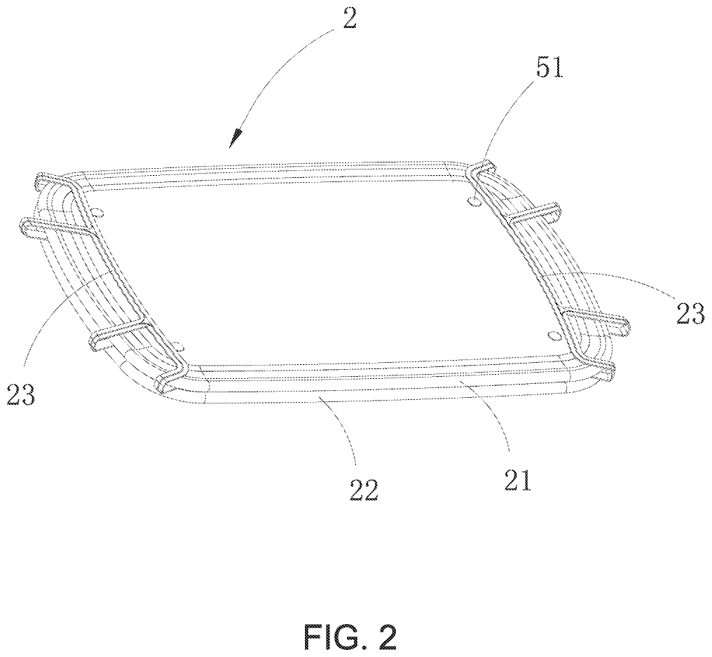

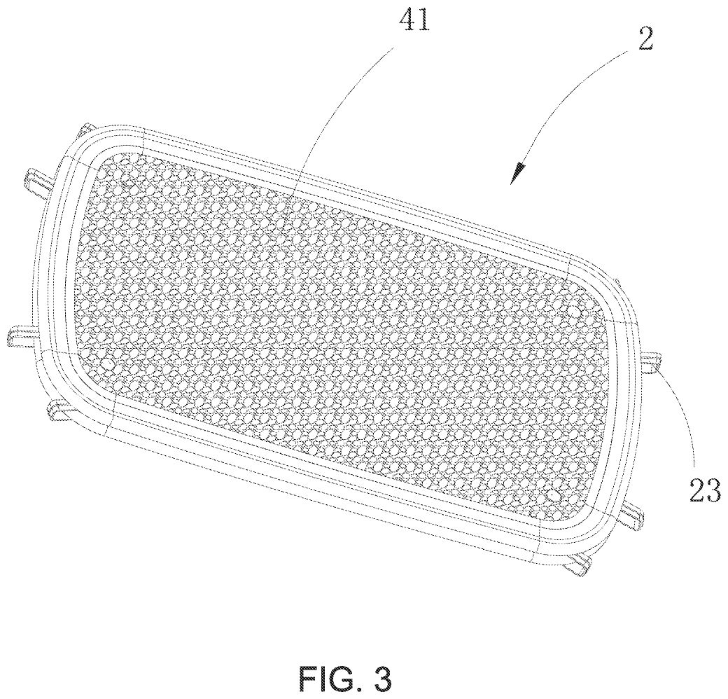

As shown in FIGS. 1 to 3, a vehicle-mounted fixing device for an electronic product is provided in the embodiment of the present application, which comprises:

an elastic webbing 1, detachably connected to the backrest of a seat of the motor vehicle;

a fixing base 2, detachably connected to the elastic webbing 1;

an elastic fastening element 23, connected to the fixing base 2, for fastening the electronic product to the fixing base 2.

In the technical solution of the present application, the elastic webbing 1 is fixed to the backrest of a seat of the motor vehicle, the electronic product is fastened to the fixing base 2 by the elastic fastening element 23, and then the fixing base 2 is fixed to the elastic webbing 1, so that the electronic product can be tightly fastened to the backrest of the seat of the motor vehicle to prevent the electronic product from shaking or even falling due to the bumpy driving of the motor vehicle when the electronic product is directly held.

In addition, the inventors have found that the bumpy driving of the motor vehicle may cause the electronic product to shake. Staring at the screen of a shaking electronic product, such as a tablet computer or a game console, will cause the angle of the lens of the eye to change continuously. If you do this for a long time, eyes will be very tired and it will easily lead to myopia. Through the technical solution of the present application, the electronic product is fixed on the backrest of the front seat, so that the vibration of the electronic product is consistent with the bump frequency of the motor vehicle, and the changing angle and frequency of the eye lens are reduced, thereby effectively reducing and alleviating eye fatigue.

In a further technical solution, the elastic fastening element 23 comprises elastic cord or nylon cord or elastic band. As a result, the fastening strength of the electronic product fixed to the backrest of the seat of the motor vehicle is further strengthened, the shaking of the electronic product is further reduced, and the eye fatigue is further reduced.

In a further technical solution, the elastic webbing comprises nylon webbing or elastic band or nylon mixed elastic band. The elastic band comprises a wide elastic band. As a result, the fastening strength of the electronic product fixed to the backrest of the seat of the motor vehicle is further strengthened, the shaking of the electronic product is further reduced, and the eye fatigue is further reduced.

In a further technical solution, the material of the elastic fastening element 23 comprises silica gel; the fixing base 2 comprises a first layer board 21 and a second layer board 22, wherein the elastic fastening element 23 is clamped between the first layer board 21 and the second layer board 22, the left and right ends of the elastic fastening element 23 respectively protrude from the first layer board 21 and are attached to an upper surface of the first layer board 21 in a curved manner. As a result, the fastening strength of the electronic product fixed to the backrest of the seat of the motor vehicle is further strengthened, the shaking of the electronic product is further reduced, and the eye fatigue is further reduced.

In a further technical solution, the elastic webbing 1 is provided with a first Hook-and-loop fastener. Specifically, the loop surface 31 (LOOP) of the first Hook-and-loop fastener and the hook surface 32 (HOOK) of the first Hook-and-loop fastener are respectively provided at the front end and the rear end of the elastic webbing 1, and the front end and the rear end of the elastic webbing 1 are adhered to each other by a first Hook-and-loop fastener to fasten the elastic webbing 1 to the backrest of the seat of the motor vehicle. As a result, the fastening strength of the electronic product fixed to the backrest of the seat of the motor vehicle is further strengthened, the shaking of the electronic product is further reduced, and the eye fatigue is further reduced.

In a further technical solution, the vehicle-mounted fixing device for electronic products further comprises a second Hook-and-loop fastener, and the fixing base 2 pasted on the elastic webbing 1 through the second Hook-and-loop fastener. As a result, the fastening strength of the electronic product fixed to the backrest of the seat of the motor vehicle is further strengthened, the shaking of the electronic product is further reduced, and the eye fatigue is further reduced.

In a further technical solution, the elastic fastening element 23 is arranged on a front end of the fixing base 2, and a loop surface 41 (LOOP) of the second Hook-and-loop fastener is arranged on a rear end of the fixing base 2, and a hook surface 42 (HOOK) of the second Hook-and-loop fastener is arranged on the elastic webbing 1. As a result, the fastening strength of the electronic product fixed to the backrest of the seat of the motor vehicle is further strengthened, the shaking of the electronic product is further reduced, and the eye fatigue is further reduced.

In a further technical solution, the elastic fastening element 23 is arranged on a front end of the fixing base 2, and a hook surface 42 (HOOK) of the second Hook-and-loop fastener is arranged on a rear end of the fixing base 2, and a loop surface 41 (LOOP) of the second Hook-and-loop fastener is arranged on the elastic webbing 1. As a result, the fastening strength of the electronic product fixed to the backrest of the seat of the motor vehicle is further strengthened, the shaking of the electronic product is further reduced, and the eye fatigue is further reduced.

In a further technical solution, the first layer board 21 and the second layer board 22 are fixed by screws 51, and a silicone anti-skid pattern is arranged in the middle of the elastic fastening element 23. By setting the silicone anti-skid pattern, the elastic fastening element 23 is more firmly clamped between the first layer board 21 and the second layer board 22.

During use: Release the elastic band, around the backrest of a seat of the motor vehicle, wherein the elastic band can be placed horizontally or vertically. The loop surface 31 of the first Hook-and-loop fastener is attached to the hook surface 32 of the first Hook-and-loop fastener; After firmly wrapping the elastic band on the seat, take out the fixing base 2, and paste the loop surface 41 of the second Hook-and-loop fastener of the fixing base 2 to the hook surface 42 of the second Hook-and-loop fastener of the elastic band. After pasting firmly, take out the tablet computer, firstly fasten one side of the tablet computer to the side of the elastic fastening element 23 of the fixing base 2, and then snap the other side of the tablet computer to the other side of the elastic fastening element 23 of the fixing base 2. The elastic fastening element 23 is preferably made of silicone material, which is soft and elastic, and can be stretched.

From the above, it can be seen that the present application has the above-mentioned excellent characteristics, so that it can improve the performance which is not available in the prior art in use, and has practicability, and becomes a product with great practical value.

The above contents are only preferred embodiments of the present application, and for those of ordinary skill in the art, according to the idea of the present application, there will be changes in the specific embodiments and application scopes. The contents of this specification should not be construed as limiting the present application.

What is claimed is:

1. A vehicle-mounted fixing device for electronic products, comprising:
an elastic webbing, detachably connected to the backrest of the motor vehicle seat;
a fixing base, detachably connected to the elastic webbing;
an elastic fastening element, connected to the fixing base, for fastening the electronic product to the fixing base.

2. The vehicle-mounted fixing device for electronic products according to claim 1, wherein the elastic fastening element comprises elastic cord or nylon cord or elastic band.

3. The vehicle-mounted fixing device for electronic products according to claim 1, wherein the elastic webbing comprises nylon webbing or elastic band or nylon mixed elastic band.

4. The vehicle-mounted fixing device for electronic products according to claim 1, wherein material of the elastic fastening element comprises silica gel; the fixing base comprises a first layer board and a second layer board, wherein the elastic fastening element is clamped between the first layer hoard and the second layer board, the left and right ends of the elastic fastening element respectively protrude from the first layer board and are attached to an upper surface of the first layer board in a curved manner.

5. The vehicle-mounted fixing device for electronic products according to claim 1, wherein the elastic webbing is provided with a first Hook-and-loop fastener.

6. The vehicle-mounted fixing device fir electronic products according to claim 1, wherein further comprising a second Hook-and-loop fastener, and the fixing base pasted on the elastic webbing through the second Hook-and-loop fastener.

7. The vehicle-mounted fixing device for electronic products according to claim 6, wherein the elastic fastening element is arranged on a front end of the fixing base, and a loop surface of the second Hook-and-loop fastener is arranged on a rear end of the fixing base, and a hook surface of the second Hook-and-loop fastener is arranged on the elastic webbing.

8. The vehicle-mounted fixing device for electronic products according to claim 6, wherein the elastic fastening element is arranged on a front end of the fixing base, and a hook surface of the second Hook-and-loop fastener is arranged on a rear end of the fixing base, and a loop surface of the second Hook-and-loop fastener is arranged on the elastic webbing.

9. The vehicle-mounted fixing device for electronic products according to claim 4, wherein the first layer board and the second layer board are fixed by screws, and a silicone anti-skid pattern is arranged in the middle of the elastic fastening element.
